(19) United States
(12) Patent Application Publication
(10) Pub. No.: US 2026/0106831 A1
(43) Pub. Date: Apr. 16, 2026

(54) LOAD BALANCING METHOD, SERVER, DATA CENTER NETWORK SYSTEM AND ELECTRONIC DEVICE

(71) Applicant: CLOUD INTELLIGENCE ASSETS HOLDING (SINGAPORE) PRIVATE LIMITED, Singapore (SG)

(72) Inventor: Bowen YANG, Hangzhou, Zhejiang (CN)

(73) Assignee: CLOUD INTELLIGENCE ASSETS HOLDING (SINGAPORE) PRIVATE LIMITED, Singapore (SG)

(21) Appl. No.: 19/115,777

(22) PCT Filed: Sep. 25, 2023
(86) PCT No.: PCT/CN2023/121262

§ 371 Date: Mar. 26, 2025

(30) Foreign Application Priority Data
Sep. 27, 2022 (CN) 202211185779.X

(51) Int. Cl. H04L 47/125

(52) U.S. Cl. CPC H04L 47/125

(57) ABSTRACT

A load balancing method applies to a server which has a plurality of processors, wherein a virtual switch and a plurality of virtual machines are run on the server, and the virtual switch processes, by means of the plurality of processors, data forwarding between the plurality of virtual machines and data forwarding between each of the plurality of virtual machines and an external device, which is connected to the server. The load balancing method comprises: determining data queues which are respectively associated with a plurality of processors; respectively monitoring said data in the plurality of data queues, so as to determine load information of the plurality of processors; and when it is determined, on the basis of the load information of the plurality of processors, that there is load imbalance, adjusting data queues which are associated with some of the plurality of processors.

### CROSS REFERENCE TO RELATED APPLICATIONS

The present disclosure is a National Stage Application of International Application NO. PCT/CN2023/121262, filed on Sep. 25, 2023, which claims priority of Chinese Patent Application No. 202211185779.X, filed with the Chinese Patent Office on Sep. 27, 2022, entitled “LOAD BALANCING METHOD, SERVER, DATA CENTER NETWORK SYSTEM AND ELECTRONIC DEVICE”, the entire contents of the above mentioned applications are incorporated herein by reference.

### TECHNICAL FIELD

The present disclosure relates to the field of computer technologies, and in particular, to a load balancing method, a server, a data center network system, and an electronic device.

### BACKGROUND

At present, virtualization technology is widely used in various fields. Virtualization technology can be used to virtualize multiple virtual machines on a physical device for virtualizing the network, and a virtual switch is a key component to realize network virtualization in the physical device, which can play the role of connecting physical networks and virtual machines, and carries the data forwarding and processing of virtual machines.

In a virtualized network, a virtual machine is connected to a virtual switch through its internal virtual network card, and the virtual switch often uses multiple processors to process the network data of the virtual machine. Generally, different virtual machines are configured with different counts of virtual network cards, and in the case that the virtual network card supports multiple data queues, the counts of data queues maintained in different virtual network cards are also different, and the amount of data received and sent corresponding to different data queues may also be different. In the related art, uneven traffic load will lead to the load of a single processor being too large, which is easy to cause network packet loss, delay, jitter and other problems.

### SUMMARY

In view of the aforementioned problems, the present disclosure provides a load balancing method, a server, a data center network system, and an electronic device that solve the aforementioned problems or at least partially solve the aforementioned problems.

In an embodiment of the present disclosure, a load balancing method is provided. The method applies to a server having a plurality of processors, a virtual switch and a plurality of virtual machines run on the server, and the virtual switch is for forwarding data among the plurality of virtual machines and between the plurality of virtual machines and an external device connected to the server by using the plurality of processors; and the method includes:
determining one or more data queues associated with each of the plurality of processors, where each data queue is configured to store data to be forwarded, and each processor is configured to process data to be forwarded in the data queues associated with the processor;
monitoring data to be forwarded in the data queues respectively to determine load information of each of the plurality of processors;
in response to determining that a load imbalance exists based on the load information of the plurality of processors, adjusting data queues associated with a part of the plurality of processors.

In another embodiment of the present disclosure, a server is provided. The server includes a plurality of processors, and a virtual switch and a plurality of virtual machines are run on the server.

The virtual switch is configured for forwarding of data among the plurality of virtual machines and between the plurality of virtual machines and an external device connected to the server by using the plurality of processors, and is configured for determining one or more data queues associated with each of the plurality of processors; where each data queue is configured to store data to be forwarded, and each processor is configured to process data to be forwarded in the data queues associated with the processor; and the virtual switch monitors data to be forwarded in the data queues respectively to determine load information of each of the plurality of processors, and in response to determining that a load imbalance exists based on the load information of the plurality of processors, the virtual switch adjusts data queues associated with a part of the plurality of processors.

In yet another embodiment of the present disclosure, a data center network system is provided. The system comprises a plurality of servers connected to a network.

Each server comprises a plurality of processors, and a virtual switch and a plurality of virtual machines are run on the server;

The virtual switch is configured for forwarding of data among the plurality of virtual machines and between the plurality of virtual machines and an external device connected to the server by using the plurality of processors, and is configured for determining one or more data queues associated with each of the plurality of processors; where each data queue is configured to store data to be forwarded, and each processor is configured to process data to be forwarded in the data queues associated with the processor; and the virtual switch monitors data to be forwarded in the data queues respectively to determine load information of each of the plurality of processors, and in response to determining that a load imbalance exists based on the load information of the plurality of processors, the virtual switch adjusts data queues associated with a part of the plurality of processors.

In yet another embodiment of the present disclosure, an electronic device is provided. The electronic device includes a storage and a plurality of processors.

The storage stores one or more computer instructions.

The plurality of processors, respectively coupled to the storage, is configured to call the one or more computer instructions to virtualize a virtual switch and a plurality of virtual machines, where the virtual switch is for forwarding data among the plurality of virtual machines and between the plurality of virtual machines and an external device connected to the server by using the plurality of processors, and for balancing loads of the plurality of processors through steps in the load balancing method according to any example of the present disclosure.

According to the technical solution provided in the embodiments of the present disclosure, data to be forwarded and processed in each of the plurality of data queues is monitored to determine load information of each of the plurality of processors, and when it is determined that a load imbalance exists based on the load information of the plurality of data processors, the load balance of the processors in the virtual switch is dynamically ensured by adjusting the data queues associated with a part of the plurality of processors, In addition, the whole solution provided in the present disclosure is simple to realize and is less calculation intensive, which is beneficial to improving the adjustment efficiency of the data queues associated with a part of the plurality of processors when a load imbalance exists among the processors.

Further, according to the technical solutions provided in the embodiments of the present disclosure, on the basis that a plurality of data queues corresponding to a virtual network card in a virtual machine are determined, data queues are configured for each of the plurality of processors, so that the counts of the data queues associated with each of the plurality of processors are balanced and the plurality of data queues of a same virtual network card are associated with different processors. Static load balancing may be provided for the processors in an initialization phase by adopting this association configuration manner.

### BRIEF DESCRIPTION OF DRAWINGS

In order to more clearly illustrate the examples of the present disclosure or the technical solutions in the related art, a brief introduction to the accompanying drawings used in the descriptions of the embodiments or the related art are made in the following. Obviously, the accompanying drawings in the following descriptions illustrate some embodiments of the present disclosure. For those of ordinary skill in the art, other accompanying drawings may also be derived from these accompanying drawings without creative effort.

FIG. 1a is a schematic diagram illustrating a principle of communication connection between a virtual switch and virtual machines in a virtual network.

FIG. 1b is a schematic diagram illustrating the principle of communication connection between a virtual switch and virtual machines in another virtual network.

FIG. 2 shows a software architecture of a virtual switch provided in the present disclosure.

FIG. 3 is a schematic flowchart of a load balancing method provided in an embodiment of the present disclosure.

FIG. 4 is a schematic diagram illustrating a principle of configuring associated data queues for a plurality of processors according to an embodiment of the present disclosure.

FIG. 5 is a schematic flowchart of configuring associated data queues for a plurality of processors according to an embodiment of the present disclosure.

FIG. 6a is a schematic diagram illustrating a principle of adjusting data queues associated with some of the processors according to an embodiment of the present disclosure.

FIG. 6b is a schematic flowchart of adjusting data queues associated with some of the processors according to an embodiment of the present disclosure.

FIG. 7a is a schematic diagram illustrating a scene of a queue swap scheme provided in an embodiment of the present disclosure.

FIG. 7b is a schematic diagram illustrating a scenario corresponding to a queue migration scheme provided in an embodiment of the present disclosure.

FIG. 8 is a schematic structural diagram of a load balancing device according to another embodiment of the present disclosure.

### DETAILED DESCRIPTION

With the technology development of a cloud computing data center, virtualization technology, as an important technology in cloud computing, has been widely used. Virtualization technology can be used to virtualize multiple Virtual Machines (VMs) on a physical device to virtualize the network, so that the computing resources on the physical device can be fully utilized. Virtual machine (VM) refers to a complete computer system with complete hardware system functions simulated by software and running in a completely isolated environment. Work that can be done in a physical computer can be done in a virtual machine. When creating a virtual machine in a computer, it is necessary to use part of a hard disk and storage capacity of the physical machine as the hard disk and storage capacity of the virtual machine. Each virtual machine can operate as a physical machine. Virtual switches are used for communications between virtual machines and between virtual machines and external networks.

Typically, a virtual machine has one or more virtual network cards. For a virtual machine inside a physical server, the virtual network card is generally bridged on a virtual bridge or virtual switch on the physical server. Thus, virtual machines can communicate with each other directly through a virtual layer 2 forwarding device while bypassing a physical network card. But the interaction between the virtual machines and the outside must go through a physical network card.

In a cloud computing environment, computing resources are segmented, virtual machines run on a server, the virtual machines also need network cards to realize interconnection and intercommunication, but the network cards of the virtual machines are not physical, virtual machines are connected to a virtual switch through virtual network cards, and the virtual switch forwards traffic between the virtual machines on the same server. If the virtual switch is connected to the server's hardware network card, the virtual machines can communicate with the outside of the server.

A virtual network card is obtained by a simulation by the CPU. A virtual network card has one or more data queues (or send and receive queues). The data queue is also obtained by a simulation, which occupies a piece of storage on the server.

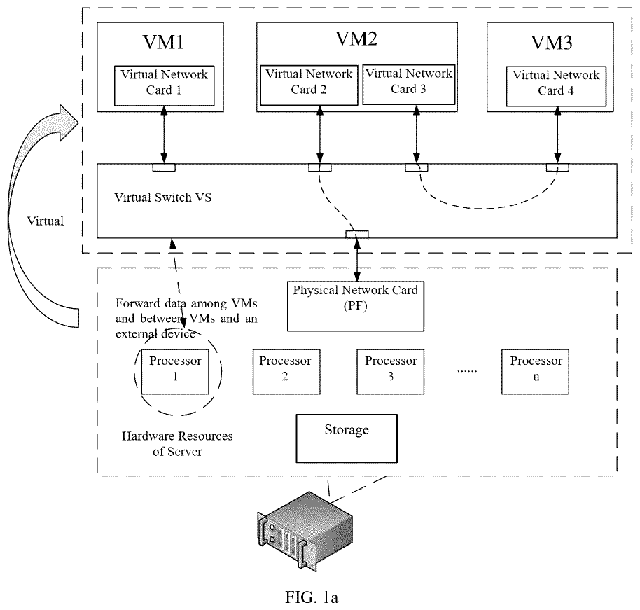

In a network virtualization scenario, a Virural Switch (VS) is a key component to implement network virtualization in a physical device, and it can provide services such as data forwarding and processing (such as error checking and address mapping maintenance) for a virtual network card and a physical network card, so that communication connections can be established between virtual machines in the virtual network or between the virtual machine and an external device outside the virtual network (such as an external Personal Computer (PC)) to realize data transmission. Where each virtual machine has its own virtual network card, the external device has its own physical network card, and the virtual machine and the external device are respectively connected to the virtual switch through their corresponding virtual network card and physical network card. The virtual switch technology is utilized to combine two physically connected switches to present a logical virtualized switch as the virtual switch to the outside. Specifically, as shown in FIG. 1a, virtual machines VM1, VM2, and VM3 and an external device (not shown in the figure) are connected to the virtual switch VS through respective corresponding virtual network cards and communicate with the external device through a physical network card. According to actual usage requirements, one or more than two virtual network cards can be configured on a virtual machine. Typically, a virtual network card has a data queue for caching data, that is, all data received by the virtual network card enters this one data queue, and then the virtual switch uses a processor (such as Central Processing Unit (CPU)) to fetch data from that data queue for processing, and if the data is not fetched in time, packet loss will occur. The situation that a virtual switch uses a processor to process data of a data queue untimely is called an interrupt. Once the data traffic is particularly large, that the virtual network card uses one data queue for caching data is easy to cause data blocking, and the processor will also suffer a high load, and there is a performance bottleneck. In response to the aforementioned problem of a virtual network card having a single data queue, a multi-queue function is developed for a network card (such as a virtual network card). The multi-queue of the network card means that one network card can have a plurality of data queues, and after data being received, the data can be hashed according to quintuple information carried by the data so as to be cached into one data queue of the plurality of data queues. And the plurality of data queues in the network card are respectively bound to different processors through an interruption, so as to solve the processing bottleneck of a single CPU when the network data traffic rises, and improve the network PPS (Packet Per Second, i.e., the count of data packets transmitted per second) and bandwidth performance. Based on this, in a case that the virtual network cards as shown in FIG. 1a support the multi-queue function, accordingly, the virtual switch may use a plurality of processors to perform data forwarding between a plurality of virtual machines and between the virtual machines and external devices. However, considering that the counts of data queues maintained in different virtual network cards are different due to the difference in performance of the virtual network cards, the amount of data corresponding to different data queues may also be different, which may lead to uneven data processing load among multiple processors of the virtual switch, resulting in that one or two processors are overloaded as shown in FIG. 1b (for example, processor n, load 90%), which will cause network packet loss, delay, jitter and other problems. In order to improve the operational stability and data processing quality of a virtual switch, how to distribute the data of virtual network cards of a virtual machine to a plurality of processors of the virtual switch for processing so as to ensure the load balance of each processor is to be considered.

In order to ensure the load balance of each processor in the virtual switch, embodiments of the present disclosure provide a load balancing technical solution. In order to enable those skilled in the art to better understand the solution of the present disclosure, the technical solution of the embodiments of the present disclosure will be clearly and completely described in the following in conjunction with the accompanying drawings in the embodiments of the present disclosure.

In some of flows described in the specification, claims, and drawings of the present disclosure, there are a number of operations that appear in a particular order, and the operations may be performed or performed in parallel out of the order as they appear herein. The numbers of operations, such as 101, 102, etc., are only used to distinguish different operations, and the numbers themselves do not represent any execution order. Additionally, the processes may include more or fewer operations, and the operations may be performed sequentially or in parallel. It should be noted that the descriptions of “first”, “second”, etc. in this paper are used to distinguish different messages, devices, modules, etc., and do not represent the order, nor do they limit that “first” and “second” are different types. However, the term “or/and” in the present disclosure is only an association relationship describing associated objects, indicating that there may be three relationships, for example, “A or/and B” indicates that there may be three cases of A alone, A and B simultaneously, and B alone; the character “/” in the present disclosure generally indicates that the associated objects belong to an “or” relationship. It is also noted that the terms “comprises,” “comprising,” or any other variation thereof, are intended to cover a non-exclusive inclusion, such that a product or system that comprises a series of elements includes not only those elements but also other elements not expressly listed or inherent to such product or system. Without further restriction, an element defined by the statement “including a . . . ” does not preclude the presence of another identical element in the product or system that includes the element. In addition, the embodiments described below are only some of the embodiments of the present disclosure, but not all of the embodiments. Based on the embodiments in the present disclosure, all other embodiments obtained by those skilled in the art without creative work belong to the scope of protection of the present disclosure.

Before the embodiments of the load balancing method provided in the embodiments of the present disclosure are described, a virtual switch that is invovled to implement the method provided in the present disclosure is briefly described.

The virtual switch involved for implementing the method provided in the present disclosure is a virtual switch (VS) 200 as shown in FIG. 1b. VS is a switch implemented based on software. Specifically, the VS may be a conventional open source software switch (Open VSwitch, OVS), or may also be an OVS supporting a DPDK (Data Plane Development Kit), that is, OVS-DPDK, etc., which are not limited in the embodiments of the present disclosure. In a specific implementation, as shown in FIG. 1b, a plurality of virtual machines (Virtual Machine, VM) 100 may be connected to the VS, and there are a plurality of processors (for example, processor 1 to processor n). The VM can be considered as a computer system simulated on a physical device through software with complete hardware system functions, and runs in a completely isolated environment, and can provide the functions of a physical computer. It should be noted that, in the embodiment of the present disclosure, the VM connected to the VS has at least one virtual network card, and the virtual network card may support a multi-queue function, that is, the virtual network card has at least one data queue for caching data to be forwarded. The multiple data queues of the virtual network card are not shown in FIG. 1b.

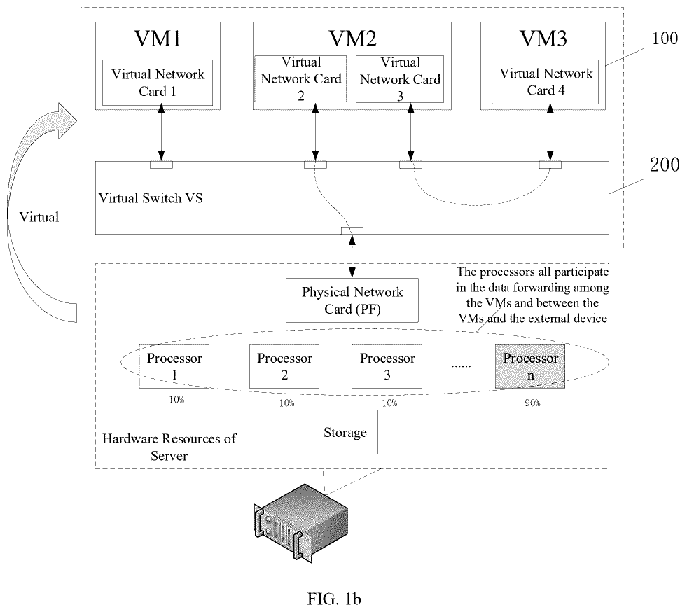

As shown in FIG. 1b, the software architecture of the VS may be specifically implemented by adopting a software architecture in which a control plane 10 and a forwarding plane 20 are separated as shown in FIG. 2. That is, the VS mainly includes two functional modules of the control plane 10 and the forwarding plane 20.

The forwarding plane 20 is configured to process data to be forwarded in a plurality of data queues through a plurality of processors, where each processor processes the data to be forwarded in at least one data queue associated with the processor, and each processor may be, but not limited to, a CPU, a GPU, etc.

The control plane 10 is provided with a load balancing module 110 configured to determine a plurality of data queues and configure associated data queues respectively for the plurality of processors, so that the counts of the data queues associated with the plurality of processors are balanced, and a plurality of data queues corresponding to a same virtual network card are associated with different processors. For example, q11 is an associated data queue configured for CPU0.

Further, the forwarding plane 20 is configured to monitor data to be forwarded and processed in each of the plurality of data queues, and feed back a monitoring result to the control plane 10.

The control plane 10 is further configured to determine the load information of the plurality of processors based on the monitoring result fed back by the forwarding plane 20, and when determining that there is a load imbalance based on the load information of the plurality of processors, adjust data queues associated with part of the plurality of processors.

In specific implementation, in addition to the load balancing module 110, the control plane 10 may further be provided with a configuration management module 120 and a data collection module 130. After the load balancing module 110 on the control plane 10 determines a plurality of data queues, the configuration management module 120 may respectively configure associated data queues for a plurality of processors. When the control plane 10 receives the monitoring result fed back by the forwarding plane 20 with respect to the data to be forwarded and processed in each of the plurality of data queues, the control plane 10 may complete the process through the data collecting module 120, so as to determine the load information of the plurality of processors based on the monitoring result fed back by the forwarding plane 10. In addition, when the control plane 10 determines that a load imbalance exists based on the load information of the plurality of processors, after adjusting the data queues associated with part of the plurality of processors, the control plane 10 may further send an adjustment result to the configuration management module 110, so that the configuration management module 110 updates the association information of the processors and the data queues stored therein, thereby facilitating the management of the association between the processors and the data queues according to the updated association information of the processors and the data queues.

The specific implementation of the functions of each module and/or each unit in the virtual switch software architecture shown in FIG. 2 may be referred to the related contents in the following, and will not be described in detail here.

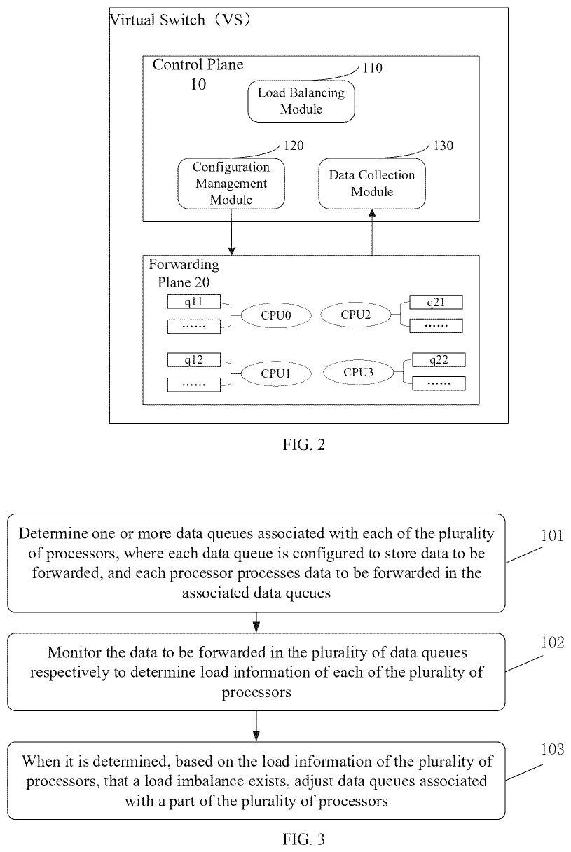

FIG. 3 illustrates a schematic flowchart of a load balancing method provided in an embodiment of the present disclosure. The load balancing method is applicable to a server having a plurality of processors (or referred to as a multi-core server) as shown in FIG. 1b. A virtual switch and a plurality of virtual machines operate on the server, and the virtual switch performs, through the plurality of processors, the data forwarding among the plurality of virtual machines and among the plurality of virtual machines and external devices connected to the server. The virtual switch (VS) is a switch implemented based on software. For example, the VS may be implemented by adopting a software architecture in which the control plane 10 and the forwarding plane 20 are separated as shown in FIG. 2. The control plane 10 is provided with a load balancing module 110. A description of the specific software architecture of the VS can be referred to the aforementioned related content. That is, the load balancing method provided in the example of the present disclosure is a method performed by a software program corresponding to the control plane 10 in the virtual switch. As shown in FIG. 3, the load balancing method includes the following steps.

101. One or more data queues associated with each of the plurality of processors are determined, where each data queue is configured to store data to be forwarded, and each processor is configured to process data to be forwarded in the data queues associated with this processor.

102. The data to be forwarded in the data queues is monitored respectively to determine load information of each of the plurality of processors.

103. When it is determined, based on the load information of the plurality of processors, that a load imbalance exists, data queues associated with a part of the plurality of processors are adjusted.

In the above 101, the data queue refers to a queue for storing data to be forwarded in a virtual network card in a virtual machine. In this embodiment, one virtual machine has at least one virtual network card, and each virtual network card may support the multi-queue function. That is, the count of data queues that each virtual network card may have may be greater than or equal to one. During specific implementation, the count of the data queues of the virtual network card is determined by a parameter provided by a virtual network card driver, where the parameter is used for specifying the count of hardware queues of the virtual network card, for example, the count of data queues of the virtual network cards specified by the parameter may be 2, 4, 8, etc., which is not limited herein. It should be noted that the above parameter determines a maximum count of data queues that a virtual network card may have, and does not indicate the count of data queues currently activated in a virtual network card. The count of the currently activated data queues in a virtual network card is a count of data queues to be activated when a virtual network card driver corresponding to the virtual network card is being loaded. A maximum count of the data queues of the virtual network card is determined by obtaining the model of the virtual network card, and based on the maximum count in combination with the count of processors of a virtual switch connected to the virtual network card, the count (Sum) of data queues to be activated of the virtual network card is obtained through the following formula: Sum=Min (the maximum count of data queues of the virtual network card, the count of processors in the virtual switch). Finally, the data queues in the virtual network card are activated according to the obtained count of data queues to be activated, and the activated data queues can be used to store the data to be forwarded.

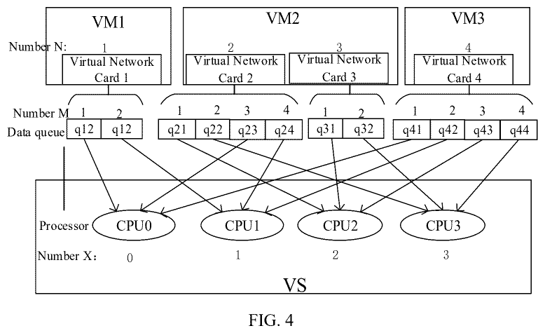

For example, referring to the virtual network shown in FIG. 1b, each of a plurality of virtual machines (for example, VM1, VM2, and VM3) is connected to a virtual switch (i.e., VS) by connecting at least one virtual network card in the virtual machine with a corresponding virtual port (not shown in the figure) provided on the virtual switch. The virtual switch has four processors (that is, CPU0-CPU4). Assuming that VM1 has a virtual network card 1, and the maximum count of data queues supported by the virtual network card 1 is 2, which is less than the count of processors of the virtual switch (that is, 4). When the virtual network card driver corresponding to VM1 is being loaded, two data queues on the virtual network card 1 are activated (not shown in FIG. 1b, specifically referring to FIG. 4), so that the virtual network card 1 uses the two activated data queues to store the data to be forwarded. Similarly, the respective counts of activated data queues in virtual network cards in other virtual machines such as VM2 and VM3 can also be obtained.

Based on the above content, the data queues determined in 101 above specifically refer to the queues in the virtual network cards in the virtual machines, which are in an active state and are configured to store the data to be forwarded. Further, the data queues are determined for all virtual machines connected to the virtual switch, that is, the determined data queues may be from a same virtual network card or different virtual network cards in a same virtual machine, or may be from different virtual network cards in different virtual machines, etc., which is not limited herein. For example, as shown in FIG. 4, for all virtual machines (i.e., VM1, VM2, and VM3) connected to the virtual switch VS, the determined data queues include q11-q12, q21-q24, q31-q32, and q41-q44, which are from different virtual network cards in different virtual machines. Specifically, q11 and q12 are both from the virtual network card 1 of VM1, q21-q24, q31 and q32 are all from the virtual network cards in VM2, where q21-q24 are from virtual network card 2 in VM2, and q31 and q32 are from virtual network card 3 in VM2; and q41-q44 are all from virtual network card 4 of VM3.

Further, after the plurality of data queues are determined for the plurality of virtual network cards corresponding to the plurality of virtual machines connected to the virtual switch, the plurality of processors may be respectively configured with associated data queues according to a set pre-configured load balancing mechanism. In order to ensure a relatively good load balance among the processors in the initialization phase, in this example, when configuring associated data queues for each processor, the count of data queues of each virtual network card is fully considered, so as to configure a same count of data queues for each processor and ensure that a plurality of data queues of a same virtual network card are associated with different processors. During specific configuration, on the basis that the network card count of the plurality of virtual network cards, the data queue numbers of the data queues corresponding to each virtual network card and the processor count of the plurality of processors are obtained, according to the number of each virtual network card, the data queue number of each data queue in each virtual network card and the number of each processor, each data queue in each virtual network card may be sequentially allocated to the different processors. Based on this, in a specific implementable technical solution, the step 101 “one or more data queues associated with each of the plurality of processors are determined” in the method provided in this example may include the following steps.

1011: A plurality of data queues are obtained, where each virtual machine has at least one virtual network card, and each virtual network card corresponds to at least one data queue.

1012: For each of the plurality of processors, the processor is configured with associated data queues, so that the counts of associated data queues among the plurality of processors are balanced, and the plurality of data queues of a same virtual network card are associated with different processors, respectively.

The above 1012 “for each of the plurality of processors, the processor is configured with associated data queues, so that the counts of associated data queues among the plurality of processors are balanced, and the plurality of data queues of a same virtual network card are associated with different processors, respectively” may specifically include the following.

10121. A network card count (i.e, the count of network cards) of the plurality of virtual network cards, a data queue count (i.e, the count of data queues) of a plurality of data queues corresponding to each virtual network card and a processor count (i.e., the count of processors) of the plurality of processors are obtained.

10122. A virtual network card number N, a data queue number M and a processor number X are determined.

10123. A data queue numbered M of a virtual network card numbered N is associated with a processor numbered X.

10124. The number X is updated based on the processor count.

10125. The number M is incremented.

10126. If the incremented number M is greater than the count of data queues of the virtual network card numbered N, the number N is incremented; if the incremented number N is greater than the count of the network cards, the operation ends; if the incremented number N is not greater than the count of the network cards, the virtual network card number N is updated to the incremented number N;

10127. If the incremented number M is not greater than the count of the data queues of the virtual network card numbered N, the step of associating the data queue numbered M of the virtual network card numbered N with the processor numbered X is triggered and executed according to the incremented number M and the updated number X.

In step 10121, in order to easily distinguish different virtual network cards, data queues and processors, each virtual network card in the plurality of virtual network cards, each data queue in a plurality of data queues correspond to each virtual network card, and each processor in the plurality of processors are all provided with corresponding numbers. And the number of each virtual network card in the plurality of virtual network cards, the number of each data queue in a plurality of data queues correspond to each virtual network card, and the number of each processor in the plurality of processors may all be determined in a manner of, but not limited to, incrementing natural numbers. For example, if the count of the plurality of processors is 4, the numbers corresponding to the four processors may be 0, 1, 2 and 3 respectively, so that the above steps 10122 to 10127 can be executed according to the numbers of the virtual network cards, the numbers of the data queues and the number of the processors subsequently, thereby realizing that each processor is configured with associated data queues. In the process of executing the steps 1022 to 1027, for the step 10124 “the number X is updated based on the processor count”, an implementable technical solution is in the following.

S1, the number X is incremented.

S2, take the remainder of the incremented number X divided by the processor count.

S3, the number X is updated according to the obtained remainder.

For the specific implementation of the above S1 to S3, reference can be made to the following related examples, which will not be described in detail here.

The process described in the above steps 10121 to 10127 are the pre-configured load balancing mechanism provided in this example, and the pre-configured load balancing mechanism may be preset in the configuration management module provided in the control plane as shown in FIG. 2, so that the control plane may control the configuration management module in the initialization phase to, based on the pre-configured load balancing mechanism set in this example, associate data queues of each virtual network card to each processor with ensuring that the counts of data queues associated with each processor are balanced and a plurality of data queues of a same virtual network card are associated with different processors, respectively.

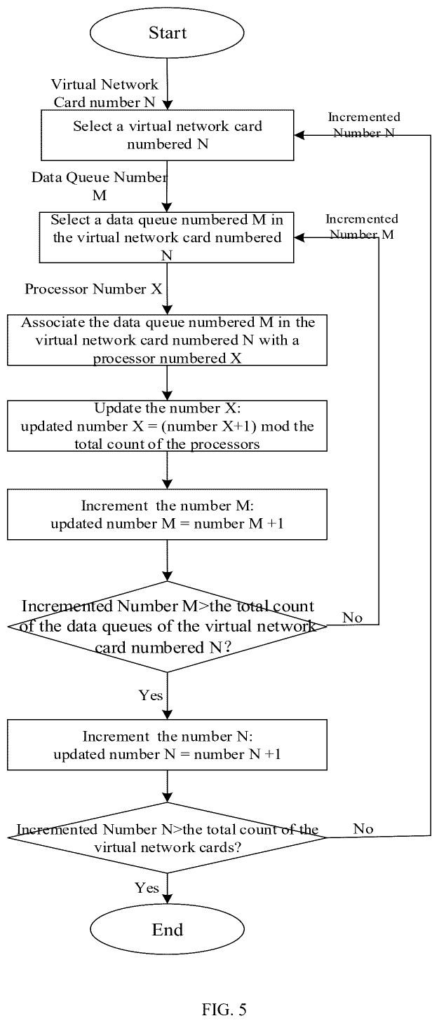

FIG. 5 is a schematic flowchart illustrating the process corresponding to the steps 10121 to 10127, of configuring associated data queues respectively for each processor. The process of configuring associated data queues respectively for each processor is described in detail in the following with reference to FIG. 5 and FIG. 4 by way of example.

In particular, as shown in FIG. 4 and FIG. 5, it is assumed that the processors in the VS refer to the CPUs, and the count of CPUs is 4. For a CPU, its corresponding CPU number is denoted by X, then the values of X can be 0, 1, 2, 3. Three virtual machines VM1, VM2, and VM3 are connected to the VS. Specifically, VM1, VM2, and VM3 are connected to the VS through virtual network card 1, virtual network card 2 and virtual network card 3, and virtual network card 4 respectively. That is, four virtual network cards are connected to the VS, and assuming that N represents the virtual network card number corresponding to the virtual network card, N may take the values 1, 2, 3, 4. Further, let M represent the data queue number corresponding to the data queue, assuming that two data queues (i.e., q11 and q12) are activated in the virtual network card 1 with the virtual network card number 1, correspondingly, the values of M may be 1 and 2; if four data queues (i.e., q21 to q24) are activated in the virtual network card 2 with the virtual network card number 2, the values of M can be 1, 2, 3, and 4 correspondingly; if two data queues (i.e., q31 and q32) are activated in the virtual network card 3 with the virtual network card number 3, the values of M can be 1 and 2 correspondingly; if four data queues (i.e., q41-q44) are activated in the virtual network card 4 with the virtual network card number 4, the values of M may be 1, 2, 3, and 4 correspondingly.

Assuming that the value of the currently determined virtual network card number N is 1, the data queue number M is 1, and the processor number X is 0, referring to FIG. 5 and FIG. 4, the data queue q11 with the data queue number 1 in the virtual network card 1 with the virtual network card number 1 which is selected from the four virtual network cards 1 to 4, is associated with the CPU 0 with the CPU number 0. Then, the processor number X may be incremented so that X is incremented from 0 to 1, and by taking the remainder of the incremented number X divided by the processor count (i.e., mod (1, 4)), a value of 1 is obtained. According to the value of 1, the number X may be updated from 0 to 1. Further, the number M is incremented so that the number M is incremented from 1 to 2. At this time, the incremented number M which is 2 is not greater than the data queue count (that is, 2) of the virtual network card numbered 1. Referring to FIG. 5 and FIG. 4, according to the incremented number M (that is, 2) and the updated number X (that is, 1), the association between the data queue q12 numbered 2 of the virtual network card numbered 1 and the processor numbered 1 (i.e., CPU 1) is triggered and executed.

Further, after the data queue q12 is associated with the CPU1, the updating of the number X and the incrementing of the number M are performed according to the updating manner described above. At this time, the number X is updated from 1 to 2, the number M is incremented from 2 to 3. The incremented number M which is 3 is greater than the data queue count (i.e., 2) of the virtual network card numbered 1. This indicates the completion of associating the data queues in the virtual network card numbered 1, with the corresponding CPUs. At this time, the number M can be reset to an initial value (such as 1), and the number N can be incremented from 1 to 2. At this time, the incremented number N which is 2 is not greater than the virtual network card count (that is, 4). It indicates that there is still a virtual network card in which the data queues stored have not been associated with corresponding CPUs, so the virtual network card number N is updated to the incremented number N. That is, the virtual network number N is updated from 1 to 2. Then according to the updated virtual network number N, in the above described manner of associating the data queues in the virtual network card 1 numbered 1 with the corresponding CPUs, each data queue in the virtual network card 2 numbered 2 is associated with a corresponding CPU. For example, the data queue q21, the data queue q22, the data queue q23 and the data queue q24 in the virtual network card numbered 2 shown in FIG. 4, are associated with CPU2, CPU3, CPU0, and CPU1, respectively.

Further, after each data queue in the virtual network card numbered 2 has been associated with the corresponding CPU, it is continued to associate the two data queues in the virtual network card 3 numbered 3 with corresponding CPUs according to the above manner. For example, the data queue q31 and the data queue q32 in the virtual network card numbered 3 as shown in FIG. 4 are respectively associated with the CPU2 and the CPU3. After that, the number N is incremented so that the number N is incremented from 3 to 4 (not greater than the count of the virtual network cards), and it is continued to associate the four data queues in the virtual network card 4 numbered 4 shown in FIG. 4 with corresponding CPUs in the manner described above. Then, the number N is incremented so that the number N is incremented from 4 to 5. At this time, the incremented number M which is 5 is greater than the count of the virtual network cards (i.e., 4), indicating that all the data queues in the four virtual network cards have been associated with the corresponding CPUs, so the operations may be ended.

Finally, according to the above steps 10121 to 10127 or the schematic flowchart corresponding to the above steps 10121 to 10127 shown in FIG. 5, the result of associating each data queue in the four virtual network cards connected to the VS with a corresponding CPU of the VS shown in FIG. 4 can refer to the associations of CPUs with data queues indicated by the “arrows” shown in FIG. 4. It can be seen from FIG. 4 that the count of data queues associated with each processor in the VS is the same, and different data queues in each virtual network card are associated with different processors respectively, which can provide better load balancing guarantee for each processor in the virtual switch in the initialization phase.

Based on the above content, after each processor in the virtual switch is configured with corresponding associated data queues, during the operation of the virtual network composed of the virtual switch and the virtual machines, after a piece of data enters a virtual machine, a virtual network card in the virtual machine will perform a calculation on five-element information composed of a source IP address, a destination IP address, a source port, a destination port, an application protocol and the like carried in the data header by using an algorithm such as hash algorithm, to obtain a hash value, so that the data is put into one of a plurality of data queues in the VS according to the hash value. Then, the one of the plurality of data queues may notify its associated processor that it has new incoming data that needs to be forwarded and processed in a manner such as, but not limited to, a hardware interrupt (IRQ), so that its associated processor fetches the data from the data queue itself for processing. It can be seen that the processor may monitor the data to be forwarded in an associated data queue according to the received hardware interrupt, and since the processors are located on the forwarding plane of the virtual switch as shown in FIG. 2, the forwarding plane can monitor data to be forwarded in each of a plurality of data queues. After the forwarding plane feeds back the monitoring result to the control plane of the virtual switch as shown in FIG. 2, the control plane may further determine data to be forwarded and processed in the plurality of data queues according to the monitoring result, so as to obtain processing information of the data to be forwarded and processed in each data queue. Because the data to be forwarded and processed in one data queue needs to be forwarded and processed by its associated processor, processor information of each data queue in the multiple data queues associated with any one of the multiple processors can be further acquired based on the obtained processing information of the data to be forward and processed in each data queue. Therefore, the load information of any one of the plurality of processors may be calculated, and the load information of the plurality of processors can be obtained. Based on the above contents, in a specific implementable technical solution, the above 102 “the data to be forwarded in each of the data queues is monitored to determine load information of each of the plurality of processors” may specifically include the following.

1021. The data to be forwarded in each of the plurality of data queues is monitored to obtain processing information of the data to be forwarded in each data queue.

1022. Based on the processing information of the data to be forwarded in each of the plurality of data queues, processing information of the data to be forwarded in each of a plurality of data queues associated with a third processor is obtained, where the third processor is any one of the plurality of processors.

1023. Load information of the third processor is calculated according to processing information of the data to be forwarded in each of the plurality of data queues associated with the third processor.

In the above 1021, the forwarding plane in the virtual switch may be used to indirectly monitor the data to be forwarded and processed in the plurality of data queues, so as to obtain the processing information of the data to be forwarded and processed in each data queue. How the forwarding plane can be used to detect data to be forwarded and processed in multiple data queues can refer to the aforementioned related content. In the above, the obtained processing information of the data to be forwarded and processed in each data queue may include, but is not limited to, the amount of the data, the data type, the data size, and the fragment size of the data.

In the above 1022 to 1023, after the processing information of the data to be forwarded and processed in each data queue is obtained, since each of the plurality of processors is configured with associated data queues in advance, based on the processing information of the data to be forwarded and processed in each data queue, the processing information of the data to be forwarded and processed in each of the plurality of data queues associated with any one of the plurality of processors (i.e., the third processor) may be obtained. Further, according to the processing information of the data to be forwarded and processed in each of the plurality of data queues associated with the third processor, the load corresponding to each of the plurality of data queues associated with the third processor may be calculated respectively, so that the load information of the third processor is obtained. Where the load information of the third processor may include, but is not limited to, a load corresponding to each of the plurality of data queues associated with the third processor, and a total load of the third processor calculated according to the load corresponding to each of the plurality of data queues associated with the third processor.

For example, as shown in FIG. 4, based on the obtained processing information of the data to be forwarded and processed in each of q11 to q12, q21 to q24, q31 to q32, and q41 to q44, the processing information of the data to be forwarded and processed in each of the three data queues of q11, q23, and q41 associated with CPU 0 can be obtained. Further, based on the processing information of the data to be forwarded and processed in each of q11, q23, and q41, the loads corresponding to q11, q23, and q41 may be respectively calculated. For example, assuming that the load corresponding to q11 is Load_q11, the load corresponding to q23 is Load_q23 and the load corresponding to q41 is Load_Q41. The load information of CPU0 that can be obtained may include: Load_q11+Load_q23+Load_q41, Load_q11, Load_q23, and Load_Q41; where Load_q11+Load_q23+Load_q41 is the total load corresponding to CPU0, and Load_q11, Load_Q23, and Load_Q41 may respectively carry an identifier of the corresponding data queue (i.e., q11, q23, q41), which may be but is not limited to the number of the data queue. Similarly, the load information of CPU1 and CPU2 can be calculated and obtained in the same manner that the load information of CPU0 is calculated and obtained. It should be noted that, the calculation of the load corresponding to a data queue according to the processing information of data to be forwarded and processed in the data queue may be referred to the related contents in the following.

Based on the determined load information of the plurality of processors, a load condition of each of the plurality of processors may be analysed for determining whether a load imbalance currently exists among each processor. In the specific implementation, since a Range value can reflect the dispersion degree of a set of data and can best reflect the size of the fluctuation range of a set of data, the Range method can be used to determine whether the storage load of each processor is currently uneven, where the Range value refers to the difference between the maximum data and the minimum data in a set of data. And only when it is determined that there is a load imbalance among the plurality of processors by using the Range method, the data queues associated with a part of the plurality of processors are adjusted, so that the problems of invalid adjustment, waste of computing resources and the like can be effectively avoided. In the above, when the load difference between the processor with the minimum load and the processor with the maximum load among the plurality of processors is calculated according to the load information of the plurality of processors and the load difference is greater than a set threshold (for example, 5%), it is considered that the a load imbalance exists among the processors. Based on this, in an implementable technical solution, the aforementioned 103 “when it is determined, based on the load information of the plurality of processors, that a load imbalance exists, the data queues associated with a part of the plurality of processors are adjusted” may specifically include the following.

1031: A first processor and a second processor in the plurality of processors are determined according to the load information of the plurality of processors, where the load of the first processor is maximum, and the load of the second processor is minimum.

1032: A load difference between the first processor and the second processor is calculated.

1033: When the load difference is greater than a threshold, the data queues associated with the first processor and the data queues associated with the second processor are adjusted.

During specific implementation, the above threshold may be flexibly set according to the actual situation, for example, 3%, 5% and 10%, which is not restricted herein. If the load difference between the first processor with a minimum load and the second processor with a maximum load among the plurality of processors, which is calculated based on the load information of the plurality of processors, is less than the threshold (e.g. 5%), it indicates that the load fluctuation range among the processors is relatively small and there is a relatively small load difference among the processors, and at this time, it may be considered that the processors are in a load balance state, and there is no need to adjust data queues associated with each of the processors. On the contrary, if the load difference is greater than the threshold (for example, 5%), it indicates that the load fluctuation range among the processors is relatively large and there is a relatively large load difference among the processors, and at this time, it can be considered that a load imbalance exists among the processors, and therefore, the data queues associated with the first processor and the data queues associated with the second processor need to be adjusted to narrow the load fluctuation range among the processors, so that the load balancing is achieved among the processors.

In the above, the first processor and the second processor are each associated with a plurality of data queues, and in adjusting the data queues associated with the first processor and the data queues associated with the second processor, on the basis of the obtained first load corresponding to each data queue associated with the first processor and the obtained second load corresponding to each data queue associated with the second processor, an adaptive queue adjustment scheme is determined in conjunction with the load difference, and the data queues associated with the first processor and the data queues associated with the second processor are adjusted according to the queue adjustment scheme. That is, the “the data queues associated with the first processor and the data queues associated with the second processor are adjusted” in the above 1033 may be specifically implemented by the following steps.

10331. The first load corresponding to each of the plurality of data queues associated with the first processor and the second load corresponding to each of the plurality of data queues associated with the second processor are obtained.

10332. A queue adjustment scheme is determined according to the first load corresponding to each of the plurality of data queues associated with the first processor, the second load corresponding to each of the plurality of data queues associated with the second processor, and the load difference.

10333. The data queues associated with the first processor and the data queues associated with the second processor are adjusted according to the queue adjustment scheme.

In a specific implementable technical solution, “the first load corresponding to each of the plurality of data queues associated with the first processor is obtained” in the above 10331 may be implemented by the following specific steps.

A11. Processing information of the first processor processing the data to be forwarded and processed in the data queue is obtained, where the processing information includes: the amount of data processed within a preset time, the receiving time and sending time of the data within the preset time, and the count of execution cycles of the processor within the preset time.

A12. The first load corresponding to the data queue is determined according to the processing information.

During specific implementation, the preset time can be flexibly set according to the actual situation, for example, the preset time can be, but is not limited to, 30 seconds, 1 minute, 2 minutes, etc. Based on the contents of steps A11 to A12 described above, assume that the preset time included in the obtained processing information of the first processor processing the data to be forwarded and processed in the data queue is T, the amount of data processed within the preset time is S (S is greater than 1), the receiving time and sending time of the wth piece of data in the S pieces of data are tw1 and tw2, and the count of execution cycles of the processor within the preset time T is n_{cycle}. According to the processing information, the following expression may be used to calculate the first load “Load” corresponding to the data queue:

$$Load = \frac{{\sum }_{S = w}^{S} ( {t}_{w 2} - {t}_{w 1} )}{{n}_{cycle}} * 100 \%$$

Similarly, in the example, for the specific implementation of “the second load corresponding to each of the plurality of data queues associated with the second processor is obtained” in 10331, reference may be made to the specific implementation of “the first load corresponding to each of the plurality of data queues associated with the first processor is obtained”, which is not further described herein.

In the manner for determining a load corresponding to a data queue described above, the load is directly quantified by the index of the execution cycle of the processor, so as to replace the conventional measurement manners such as PPS and bandwidth, which achieves higher accuracy in measuring the resource consumption of the processor.

In the above 10332, in order to select a corresponding target queue each from the plurality of data queues associated with the first processor and the plurality of data queues associated with the second processor with a relatively little amount of calculation, so as to adjust data queues associated with the first processor and the data queues associated with the second processor based on the target queues, thereby achieving load balancing among the processors. In this example, a data queue is selected from the plurality of data queues associated with the first processor as a target queue by analysing the first load corresponding to each of the plurality of data queues associated with the first processor and the load difference between the first processor and the second processor calculated in the step 1042. And a data queue is selected from the data queues associated with the first processor as another target queue, a data queue is selected from the data queues associated with the second processor as yet another target queue, respectively, by analysing the first load information corresponding to each of the data queues associated with the first processor, the second load information corresponding to each of the data queues associated with the second processor and the load difference. So that the queue adjustment scheme is determined based on the loads corresponding to the three determined target queues. That is, the aforementioned 10332 “A data queue adjustment scheme is determined according to the first load corresponding to each of the plurality of data queues associated with the first processor, the second load corresponding to each of the plurality of data queues associated with the second processor, and the load difference” may be specifically implemented through the following steps.

A21, based on the first load corresponding to each of the plurality of data queues associated with the first processor and the load difference, a data queue is selected from the plurality of data queues associated with the first processor as a first target queue.

A22, based on the first load corresponding to each of the plurality of data queues associated with the first processor, the second load corresponding to each of the plurality of data queues associated with the second processor, and the load difference, a data queue is selected from the plurality of data queues associated with the first processor as a second target queue, a data queue is selected from the plurality of data queues data queues associated with the second processor as a third target queue, respectively.

A23, the queue adjustment scheme is determined based on a load corresponding to the first target queue, a load corresponding to the second target queue, and a load corresponding of the third target queue.

In the above A21, based on the first load corresponding to each of the data queues associated with the first processor and the load difference, a difference analysis method may be used to select a data queue from the plurality of data queues associated with the first processor as the first target queue. Specifically, a specific implementable implementation solution of the above A21 “based on the first load corresponding to each of the plurality of data queues associated with the first processor and the load difference, a data queue is selected from the plurality of data queues associated with the first processor as a first target queue” is as follows.

A211, a first value of the first load corresponding to each of the plurality of data queues associated with the first processor relative to the load difference is calculated.

A212, a data queue with a minimum first value among the plurality of data queues associated with the first processor is selected as the first target queue.

In specific implementation, the first value refers to an absolute difference between a first load corresponding to each of the plurality of data queues associated with the first processor and the load difference. Specifically, assuming that a first load corresponding to the jth data queue among the plurality of data queues associated with the first processor is denoted as Load_q1_j, and the load difference is denoted as Δ, therefore abs_1, which is a first value corresponding to the jth data queue among the plurality of data queues associated with the first processor, may be calculated by using the following formula 1.

$$abs\_ 1 = \vert Load\_q 1 \_j - Δ / 2 \vert \qquad Formula 1$$

For example, referring to FIG. 4, assuming that the first processor is CPU1, where CPU1 is associated with three data queues q12, q24, and q42, let q12 be a first data queue among the three data queues q12, q24, and q42 associated with CPU1, the first value abs 1 corresponding to the first data queue among the three data queues q12, q24, and q42 associated with CPU1 is:

abs_1==|Load_q1_1-Δ/2|, where Load_q1_1 refers to the load corresponding to the q12 data queue (i.e. Load_q12).

After the first value corresponding to each of the plurality of data queues associated with the first processor is calculated, a data queue corresponding to the minimum first value among the plurality of data queues associated with the first processor is the first target queue.

In the above A22, queue grouping may be performed on the plurality of data queues associated with the first processor and the plurality of data queues associated with the second processor to obtain a plurality of queue groups each including two data queues, one of which is a data queue associated with the first processor and the other is a data queue associated with the second processor. By adopting the difference analysis method, on the basis that an absolute difference of loads corresponding to two data queues in each of the plurality of queue groups is calculated, a second value of the absolute difference corresponding to each of the plurality of queue groups relative to the load difference is further calculated, and a queue group with a minimum second value is selected as a target group, so that the second target queue and the third target queue are determined according to the two data queues in the target group. That is, a specific implementation solution of the above A22 “based on the first load corresponding to each of the plurality of data queues associated with the first processor, the second load corresponding to each of the plurality of data queues associated with the second processor, and the load difference, a data queue is selected from the plurality of data queues associated with the first processor as a second target queue, a data queue is selected from the plurality of data queues data queues associated with the second processor as a third target queue, respectively” is as follows.

A221, according to the first load corresponding to each of the plurality of data queues associated with the first processor and the second load corresponding to each of the plurality of data queues associated with the second processor, an absolute difference between loads corresponding to two data queues in each of the plurality of queue groups is calculated; where any one of the plurality of data queues associated with the first processor and any one of the plurality of data queues associated with the second processor constitute a queue group.

A222, the second value of an absolute difference corresponding to each of the plurality of queue groups relative to the load difference is calculated.

A223, a queue group with the minimum second value is selected as the target group.

A224, the data queue associated with the first processor in the target group is taken as the second target queue, and the data queue associated with the second processor in the target group is taken as the third target queue.

In the specific implementation, similar to the first value, the second value refers to an absolute difference of the absolute difference corresponding to each queue group in the plurality of queue groups relative to the load difference. Based on the contents described in the above steps A221-A222, assuming that a queue group is composed of the jth data queue q1_j among the plurality of data queues associated with the first processor and the yth data queue q1_y among the plurality of data queues associated with the second processor, the second value abs_2 corresponding to the queue group may be calculated by using the following formula 2.

$$abs\_ 2 = ‖ Load\_q 1 \_j - Load\_q1 \_y \vert - Δ / 2 \vert \qquad Formula 2$$

After the second value of the absolute difference corresponding to each queue group in the plurality of queue groups relative to the load difference is calculated based on the formula 2, the queue group corresponding to the minimum second value among the plurality of queue groups is considered to be the target group. At this time, a data queue associated with the first processor in the target group serves as the second target queue, while a data queue associated with the second processor in the target group serves as the third target queue.

After the first target queue, the second target queue and the third target queue are determined, in an implementable technical solution, the aforementioned A23 “the queue adjustment scheme is determined based on a load corresponding to the first target queue, a load corresponding to the second target queue, and a load corresponding of the third target queue” may be implemented by the following steps.

A231, a first value of a load corresponding to the first target queue relative to the load difference is obtained.

A232, a second value of an absolute difference between a load corresponding to the second target queue and a load corresponding to the third target queue relative to the load difference is obtained.

A233, the first value is compared with the second value.

A234, if the first value is less than the second value, a queue migration scheme is adopted to adjust the first target queue to be associated with the second processor.

A235, if the first value is not less than the second value, a queue swap scheme is adopted to adjust the second target queue to be associated with the second processor and to adjust the third target queue to be associated with the first processor.

For the specific implementation of the above steps A231 to A232, reference can be made to the related contents above.

In the steps A233-A235, the queue migration scheme and the queue swap scheme may be preset in a load balancing module provided on the control plane as shown in FIG. 2, so that the load balancing module determines a queue adjustment scheme from the queue migration scheme and the queue swap scheme by comparing and analysing the relationship between the first value of the load corresponding to the first target queue relative to the load difference and the second value of an absolute difference between the load corresponding to the second target queue and the load corresponding to the third target queue relative to the load difference, and calls a corresponding queue adjustment scheme from itself for subsequent adjustments of the data queues associated with the first processor and the data queues associated with the second processor according to the queue adjustment scheme. Specifically, when determining the queue adjustment scheme, in response to determining that the first value is less than the second value, it is determined to adopt the queue migration scheme for adjusting the first target queue to be associated with the second processor; on the contrary, in response to determining that the first value is greater than or equal to the second value, it is determined to adopt the queue swap scheme for adjusting the second target queue to be associated with the second processor, and adjusting the third target queue to be associated with the first processor.

In the above 10333, according to different queue adjustment schemes determined by the step 10332, the data queues associated with the first processor and the data queues associated with the second processor will be adjusted in different manners. Specifically, if the determined queue adjustment scheme is the queue migration scheme, a data queue corresponding to the first target queue among the plurality of data queues associated with the first processor is adjusted to be associated with the second processor; and if the determined queue adjustment scheme is the queue swap scheme, a data queue corresponding to the second target queue among the plurality of data queues associated with the first processor is adjusted to be associated with the second processor, and a data queue corresponding to the third target queue among the plurality of data queues associated with the second processor is adjusted to be associated with the first processor.

To sum up, in the technical solution provided in this example, on the basis that a plurality of data queues corresponding to virtual networks card in a virtual machine are determined, associated data queues are respectively configured for a plurality of processors, so that the counts of data queues associated with the plurality of processors are balanced, and the plurality of data queues of a same virtual network card are associated with different processors. This configuration association manner provides better load balancing for each processor in the initialization phase. Further, the data to be forwarded and processed in the plurality of data queues are monitored respectively to determine load information of the plurality of processors, so that when it is determined that a load imbalance exists based on the load information of the plurality of processors, the load balance of each processor in the virtual switch can be effectively ensured by adjusting data queues associated with a part of the processors in the plurality of processors. In addition, the whole solution provided in the example is simple to implement and needs less calculation amount, which are beneficial to improving the adjustment efficiency of the data queues associated with a part of the processors in the plurality of processors when the loads among the processors are uneven.

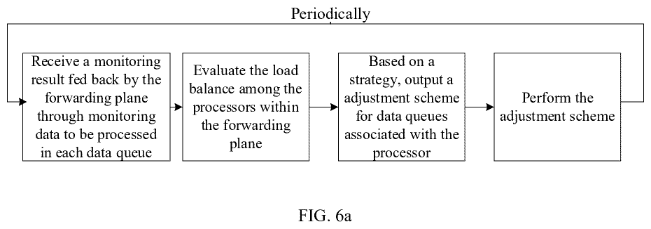

The entire implementation process described in the above 102 and 103 (that is, the above steps 1031 to 1033) is to determine the load information of the plurality of processors by monitoring the data to be forwarded and processed in the plurality of data queues, so as to adjust data queues associated with a part of the plurality of processors when it is determined that a load imbalance exists based on the load information of the plurality of processors, which can be simplified as the flow chart shown in FIG. 6a. That is, after the control plane receives a monitoring result fed back by the forwarding plane through monitoring data to be forwarded and processed in each of a plurality of data queues, the control plane evaluates the load balance of each of the plurality of processors based on a monitoring result, and when determining that a load imbalance exists, the control plane determines a corresponding queue adjustment scheme based on a strategy. Then the control plane adjusts data queues associated with a part of the plurality of processors by performing the determined queue adjustment scheme, so that loads among the processors are balanced. It should be noted that the forwarding plane and the control plane are configured in the virtual switch, and the strategy refers to the contents related to the determination of the queue adjustment scheme described above.

Further, the specific implementation of each step shown in the above FIG. 6a can be referred to FIG. 6b, that is to say, FIG. 6b illustrates a flowchart corresponding to the above 103 (i.e., the above steps 1031 to 1033) of adjusting data queues associated with a part of the plurality of processors when it is determined that a load imbalance exists among the plurality of processors based on the load information of the plurality of processors. The process of adjusting the data queues associated with a part of the plurality of processors will be described in detail with reference to an example in FIG. 6b and FIG. 4.

In particular, following the example listed in conjunction with FIGS. 5 and 4, assuming that a plurality of data queues associated with each of the four CPUs, i.e., CPU0 to CPU3 shown in FIG. 4 are as follows: the plurality of data queues associated with CPU0 include q11, q23 and q41; the plurality of data queues associated with CPU1 include q12, q24 and q42; the plurality of data queues associated with CPU2 include q21, q31 and q43; and the plurality of data queues associated with CPU3 include q22, q32, and q44. After the load information of each CPU in CPU0-CPU4 is determined by monitoring data to be forwarded and processed in the data queues q11-q12, q21-q24, q31-q32, and q41-q44, it is determined that the load of CPU1 is maximum and the load of CPU2 is minimum, and the load difference A between CPU1 and CPU2 is greater than a threshold.

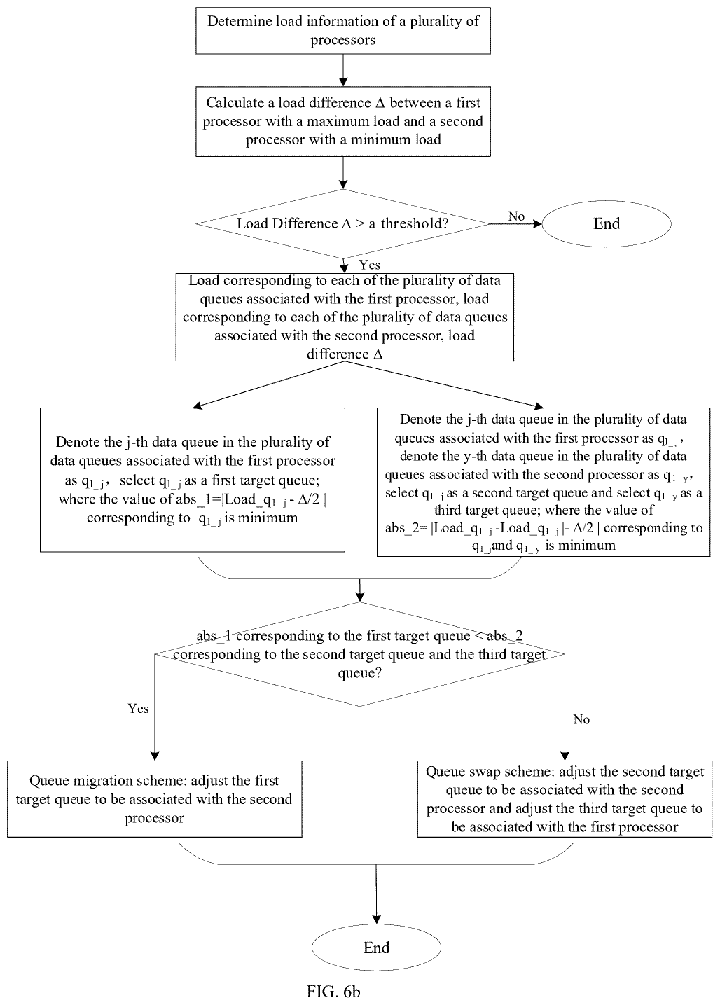

As shown in FIG. 7a, assume that the loads corresponding to the three data queues q12, q24 and q42 associated with CPU1 are 13%, 20% and 7% respectively, and the loads corresponding to the three data queues q21, q31 and q43 associated with CPU2 are 2%, 5% and 3% respectively. In conjunction with FIG. 6b, assume that the queue adjustment scheme is determined as the queue swap scheme based on the loads respectively corresponding to q12, q24, and q42 associated with CPU1, the loads respectively corresponding to q21, q31, and q43 associated with CPU2 as shown in FIG. 7a, and the load difference A (i.e. 30%). Where in the process of determining the queue swap scheme, based on the loads respectively corresponding to q12, q24, and q42 associated with CPU1, the loads respectively corresponding to q21, q31, and q43 associated with CPU2, and the load difference A, q24 is selected from q12, q24 and q42 associated with CPU1 as the second target queue, and q31 is selected from q21, q31 and q43 associated with CPU2 as the third target queue, respectively. Therefore, when the data queues associated with the CPU1 and the data queues associated with the CPU2 are adjusted, the q24 associated with CPU1 is adjusted to be associated with CPU2 and q31 associated with CPU2 is adjusted to be associated with CPU1 according to the queue swap scheme.

Referring to FIG. 7b, assume that the loads corresponding to the three data queues q12, q24 and q42 associated with CPU1 are 5%, 10% and 15% respectively, and the loads corresponding to the three data queues q21, q31 and q43 associated with CPU2 are 3%, 8% and 9% respectively. In conjunction with FIG. 6b, assume that the queue adjustment scheme is determined as the queue migration scheme based on the loads respectively corresponding to q12, q24, and q42 associated with CPU1, the loads respectively corresponding to q21, q31, and q43 associated with CPU2 as shown in FIG. 7b, and the load difference A (i.e. 10%). Where in the process of determining the queue adjustment scheme, based on the loads respectively corresponding to q12, q24, and q42 associated with CPU1, the loads respectively corresponding to q21, q31, and q43 associated with CPU2, and the load difference A, q12 is selected from q12, q24 and q42 associated with CPU1 as the first target queue. Therefore, when the data queues associated with CPU1 and the data queues associated with CPU2 are adjusted, q12 associated with CPU1 is adjusted to be associated with CPU2 according to the queue migration scheme.

The technical solution provided in the present disclosure is described above mainly from a perspective of software, and the technical solution provided in the present disclosure is described in the following from a perspective of hardware in combination with devices.

In particular, an example of that present disclosure provides a server. Referring to FIG. 1b, the server includes a plurality of processors, where a virtual switch 200 and a plurality of virtual machines 100 are run on the server. The virtual switch 200 is for the forwarding data among the plurality of virtual machines 100 and between the plurality of virtual machines 100 and an external device connected to the server by using the plurality of processors, and is configured for determining one or more data queues associated with each of the plurality of processors; where each data queue is configured to store data to be forwarded, and each processor is configured to process data to be forwarded in the data queues associated with the processor; and the virtual switch 200 monitors data to be forwarded in the data queues respectively to determine load information of each of the plurality of processors, and in response to determining that a load imbalance exists based on the load information of the plurality of processors, the virtual switch 200 adjusts data queues associated with a part of the plurality of processors.

An example of the present disclosure provides a data center network system. The data center network system includes a plurality of servers connected to a network, such as the plurality of servers shown in FIG. 1b. The server in the data center network system include a plurality of processors, and there is a virtual switch and a plurality of virtual machines which run on the server.

The virtual switch is configured for forwarding of data among the plurality of virtual machines and between the plurality of virtual machines and an external device connected to the server by using the plurality of processors, and is configured for determining one or more data queues associated with each of the plurality of processors; where each data queue is configured to store data to be forwarded, and each processor is configured to process data to be forwarded in the data queues associated with the processor; and the virtual switch monitors data to be forwarded in the data queues respectively to determine load information of each of the plurality of processors, and in response to determining that a load imbalance exists based on the load information of the plurality of processors, the virtual switch adjusts data queues associated with a part of the plurality of processors.

For the specific description of the virtual machines, the virtual network cards in the virtual machines, and the plurality of data queues corresponding to the virtual network cards, reference can be made to the related contents of the above examples.

The virtual switch 200 is a switch implemented based on software. Specifically, the virtual switch 200 may be a conventional open source software switch (Open VSwitch, OVS), or may also be an OVS supporting a DPDK (Data Plane Development Kit), that is, OVS-DPDK, etc., which are not limited in the embodiments of the present disclosure. In specific implementation, the software architecture of the virtual switch 200 may be specifically implemented by adopting a software architecture in which a control plane 10 and a forwarding plane 20 are separated as shown in FIG. 2. Where the control plane 10 is mainly responsible for functions such as configuration management of the forwarding plane 20 and data acquisition, and may be provided with a load balancing module 110. The load balancing module 110 is mainly responsible for load balancing among the processors in the forwarding plane. The forwarding plane 10 includes a plurality of processors, and is mainly responsible for data forwarding and processing. Based on this, the virtual switch 200 provided in the example may include the following.

The control plane 10, which is provided with a load balancing module 110, is configured to determine a plurality of data queues and configure associated data queues respectively for the plurality of processors, so that the counts of the data queues associated with the plurality of processors are balanced, and a plurality of data queues corresponding to a same virtual network card are associated with different processors. For example, q11 is an associated data queue configured for CPU0.

The forwarding plane 20, is configured to monitor data to be forwarded and processed in each of the plurality of data queues, and feed back a monitoring result to the control plane.

The control plane is further configured to determine the load information of the plurality of processors based on the monitoring result fed back by the forwarding plane, and when determining that there is a load imbalance based on the load information of the plurality of processors, adjust data queues associated with part of the plurality of processors.

For a detailed introduction to the specific functional modules that the virtual switch 200 may include and the functions of each module, reference may be made to the relevant contents in the above examples, and a detailed description thereof will not be made here.

In summary, the technical solution provided in the examples of the present disclosure has the following beneficial effects.

1, when configuring associated data queues for a plurality of processors, factors such as the count of data queues processed by each processor, and amounts of data traffic corresponding to different data queues in a same virtual network card under normal conditions are fully considered, so that good load balance among the processors can be ensured in the initialization phase.

2, after the configuration of the data queues associated with the processors is completed, in the running phase, it is considered that even under the condition that the count of the data queues processed by each processor is equal, a load imbalance can be caused among the processors due to the differences of real-time amounts of data traffic, data traffic types and the like corresponding to the data queues. Therefore, the load balance among the processors is evaluated by monitoring data to be forwarded and processed in each data queue so as to determine a corresponding queue adjustment scheme, and the load balance among the processors is ensured by executing the queue adjustment scheme; where in the process of determining the queue adjustment scheme, when selecting a target queue to be adjusted, a lightweight manner is adopted, which is less computation intensive.

3. When calculating a load of a data queue, the load is directly quantified by an index of the execution cycle of a processor, which replaces the conventional PPS, bandwidth and other measurement manners, and is more accurate in measuring the resource consumption of the processors.

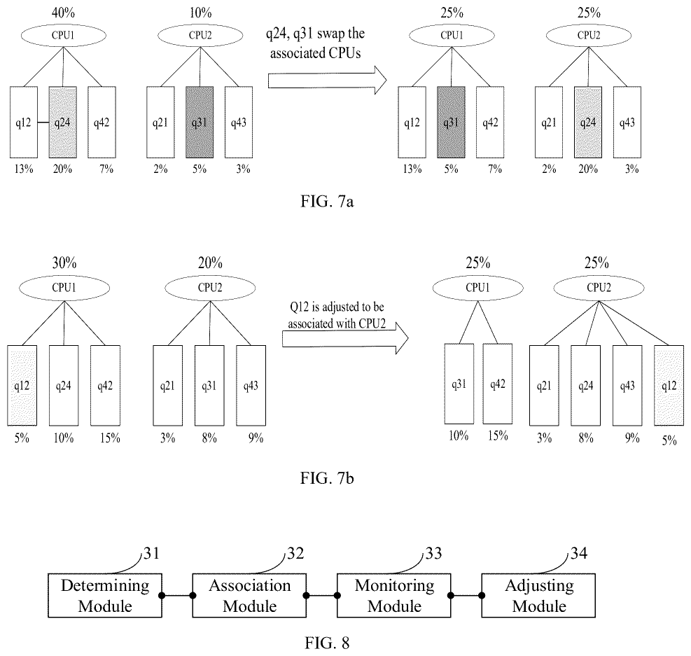

FIG. 8 is a schematic structural diagram of a load balancing device according to an example of the present disclosure. As shown in FIG. 8, the load balancing device includes a determining module 31, a monitoring module 33, and an adjusting module 34.

The determining module 31 is configured to determine one or more data queues associated with each of the plurality of processors, where each data queue is configured to store data to be forwarded, and the processor is configured to process data to be forwarded in the data queues associated with this processor.

The monitoring module 33 is configured to monitor the data to be forwarded and processed in the data queues associated with the plurality of processors to determine load information of each of the plurality of processors.

The adjusting module 34 is configured to, when it is determined, based on the load information of the plurality of processors, that a load imbalance exists, adjust data queues associated with a part of the plurality of processors.

Further, as shown in FIG. 8, the load balancing device may further include an association module 32, which is configured to obtain a plurality of data queues, where each virtual machine has at least one virtual network card, and each virtual network card corresponds to at least one data queue; and for each of the plurality of processors, configure associated data queues, so that the counts of associated data queues among the plurality of processors are balanced, and the plurality of data queues of a same virtual network card are associated with different processors, respectively.

Further, when adjusting the data queues associated with a part of the plurality of processors when it is determined, based on the load information of the plurality of processors, that a load imbalance exists, the adjusting module 34 is specifically configured to, determine a first processor and a second processor in the plurality of processors according to the load information of the plurality of processors; where the load of the first processor is maximum, and the load of the second processor is minimum; calculate a load difference between the first processor and the second processor; and when the load difference is greater than a threshold, adjust data queues associated with the first processor and data queues associated with the second processor.

Further, the first processor is associated with a plurality of data queues, and the second processor is associated with a plurality of data queue. And when adjusting the data queues associated with the first processor and the data queues associated with the second processor, the adjusting module 34 is specifically configured to obtain a first load corresponding to each of the plurality of data queues associated with the first processor and a second load corresponding to each of the plurality of data queues associated with the second processor; determine a queue adjustment scheme according to a first load corresponding to each of the plurality of data queues associated with the first processor, the second load corresponding to each of the plurality of data queues associated with the second processor, and the load difference; adjust data queues associated with the first processor and the data queues associated with the second processor according to the queue adjustment scheme.

Further, when determining a queue adjustment scheme according to the first load corresponding to each of the plurality of data queues associated with the first processor, the second load corresponding to each of the plurality of data queues associated with the second processor, and the load difference, the adjusting module 34 is specifically configured to: based on the first load corresponding to each of the plurality of data queues associated with the first processor and the load difference, select a data queue from the plurality of data queues associated with the first processor as a first target queue; based on the first load corresponding to each of the plurality of data queues associated with the first processor, the second load corresponding to each of the plurality of data queues associated with the second processor, and the load difference, select a data queue from the plurality of data queue associated with the first processor as a second target queue, and select a data queue from the plurality of data queues associated with the second processor as a third target queue, respectively; and determine the queue adjustment scheme based on a load corresponding to the first target queue, a load corresponding to the second target queue, and a load corresponding to the third target queue.

Further, when selecting a data queue from the plurality of data queues associated with the first processor as a first target queue according to the first load corresponding to each of the plurality of data queues associated with the first processor and the load difference, the adjusting module 34 is specifically configured to calculate a first value of the first load corresponding to each of the plurality of data queues associated with the first processor relative to the load difference, and take a data queue with a minimum first value in the plurality of data queues associated with the first processor as the first target queue.

Further, when according to the first load corresponding to each of the plurality of data queues associated with the first processor, the second load corresponding to each of the plurality of data queues associated with the second processor, and the load difference, selecting a data queue from the plurality of data queues associated with the first processor as the second target queue and selecting a data queue from the plurality of data queues associated with the second processor as the third target queue respectively, the adjusting module 34 is specifically configured to: according to the first load corresponding to each of the plurality of data queues associated with the first processor and the second load corresponding to each of the plurality of data queues associated with the second processor, calculate an absolute difference between loads corresponding to two data queues in each of the plurality of queue groups; where any one of the plurality of data queues associated with the first processor and any one of the plurality of data queues associated with the second processor constitute a queue group; calculate a second value of an absolute difference corresponding to each of the plurality of queue groups relative to the load difference; select a queue group with a minimum second value as a target group; take a data queue associated with the first processor in the target group as the second target queue; take a data queue associated with the second processor in the target group as the third target queue.

Further, when determining the queue adjustment scheme based on the load corresponding to the first target queue, the load corresponding to the second target queue, and the load of the third target queue, the adjustment module 34 is specifically configured to: obtain a first value of the load corresponding to the first target queue relative to the load difference; obtain a second value of an absolute difference between the load corresponding to the second target queue and the load corresponding to the third target queue relative to the load difference; compare the first value with the second value; if the first value is less than the second value, adopt the queue migration scheme for adjusting the first target queue to be associated with the second processor; and if the first value is not less than the second value, adopt the queue swap scheme for adjusting the second target queue to be associated with the second processor and adjusting the third target queue to be associated with the first processor.

Further, when obtaining a first load corresponding to a data queue in the plurality of the data queues associated with the first processor, the adjusting module 34 is specifically configured to: obtain processing information of the first processor processing the data to be forwarded and processed in the data queue, where the processing information includes: the amount of data processed within a preset time, the receiving time and sending time of the data within the preset time, and the count of execution cycles of the processor within the preset time; based on the processing information, determine the first load corresponding to the data queue.

Further, when monitoring data to be forwarded and processed in the data queues respectively to determine load information of each of the plurality of processors, the monitoring module 33 is specifically configured to: monitor the data to be forwarded and processed in each of the plurality of data queues to obtain processing information of the data to be forwarded in each data queue; based on the processing information of the data to be forwarded in each of the plurality of data queues, obtain processing information of the data to be forwarded in each of a plurality of data queues associated with a third processor; calculate load information of the third processor according to processing information of the data to be forwarded in each of the plurality of data queues associated with the third processor where the third processor is any one of the plurality of processors.

Further, when configuring associated data queues for each of the plurality of processors, the association module 32 is specifically configured to: obtain a network card count (i.e, the count of network cards) of the plurality of virtual network cards, a data queue count (i.e, the count of data queues) of a plurality of data queues corresponding to each virtual network card and a processor count (i.e., the count of processors) of the plurality of processors; determine a virtual network card number N, a data queue number M and a processor number X; associate a data queue numbered M of a virtual network card numbered N with a processor numbered X; update the number X based on the processor count; increment the number M; If the incremented number M is greater than the count of data queues of the virtual network card numbered N, increment the number N; if the incremented number N is greater than the count of the network cards, end the operation; if the incremented number N is not greater than the count of the network cards, update the virtual network card number N to the incremented number N; If the incremented number M is not greater than the count of the data queues of the virtual network card numbered N, trigger and execute the step of associating the data queue numbered M of the virtual network card numbered N with the processor numbered X according to the incremented number M and the updated number X.

Further, when updating the number X based on the processor count, the association module 32 is specifically configured to increment the number X; take the remainder of the incremented number X divided by the processor count; update the number X according to the obtained remainder.

It should be noted that the load balancing device provided in this embodiment can implement the technical solution described in the embodiment of the data load balancing method shown in FIG. 3, and the specific implementation principle of each module or unit can refer to the corresponding contents in the embodiment of the load balancing method shown in FIG. 3, which is not described in detail here.

A schematic structural diagram of an electronic device according to an embodiment of the present disclosure. The schematic diagram of the principle structure is similar to that shown in FIG. 1b. Specifically, the electronic device includes a storage and a plurality of processors. The storage stores one or more computer instructions. The plurality of processors are respectively coupled with the storage and are used for calling one or more computer instructions to virtualize a virtual switch and a plurality of virtual machines, and the virtual switch is used for processing the data forwarding among the plurality of virtual machines and among the plurality of external devices connected between the virtual machines and the server through the processors, It is also used to balance the load of the plurality of processors through the steps in the method provided by the above embodiments.

In the foregoing, the storage may be implemented by any type or combination of volatile and non-volatile storage devices, such as static random access memory (SRAM), electrically erasable programmable read only memory (EEPROM), erasable programmable read only memory (EPROM), programmable read-only memory (PROM), read-only memory (ROM), Magnetic memory, flash memory, magnetic or optical disk.

Another embodiment of the present disclosure provides a computer program product (not shown in the drawings of the specification). The computer program product includes computer programs or instructions that, when executed by a processor, cause the processor to perform the steps of the various method embodiments described above.

Correspondingly, the embodiments of the present disclosure further provide a computer-readable storage medium storing a computer program, and when the computer program is executed by a computer, the method steps or functions provided in the above embodiments can be realized.

Through the above description of the embodiments, those skilled in the art can clearly understand that the embodiments can be realized by means of software and a necessary general hardware platform, and of course, can also be realized by means of hardware. Based on such understanding, the essence of the above technical solution or the part contributing to the prior art can be embodied in the form of a software product, which can be stored in a computer-readable storage medium, such as ROM/RAM, magnetic disk, optical disk, etc., and comprises a plurality of instructions for enabling a computer device (which can be a personal computer, a server, Or network devices, etc.) To perform the methods described in the various embodiments or portions of the embodiments.

Finally, it should be noted that the above embodiments are only used to illustrate the technical solutions of the present disclosure, not to limit them. Although the present disclosure has been described in detail with reference to the foregoing embodiments, those of ordinary skill in the art should understand that the technical solutions described in the foregoing embodiments can still be modified, or some of the technical features thereof can be equivalently replaced; These modifications or replacements do not make the essence of the corresponding technical solutions deviate from the spirit and scope of the technical solutions of the embodiments of the present disclosure.

1. A load balancing method, applied to a server having a plurality of processors, where a virtual switch and a plurality of virtual machines are run on the server, and the virtual switch is configured to forward data among the plurality of virtual machines and between the plurality of virtual machines and an external device connected to the server by using the plurality of processors; wherein the load balancing method comprises:
determining one or more data queues associated with each of the plurality of processors, wherein each data queue is configured to store data to be forwarded, and each processor is configured to process data to be forwarded in the data queues associated with the processor;
monitoring data to be forwarded in the data queues respectively to determine load information of each of the plurality of processors;
in response to determining that a load imbalance exists based on the load information of the plurality of processors, adjusting data queues associated with a part of the plurality of processors.

2. The load balancing method according to claim 1, wherein determining the data queues associated with each of the plurality of processors comprises:
obtaining a plurality of data queues, wherein each virtual machine is provided with at least one virtual network card, and each virtual network card corresponds to at least one data queue;
configuring, for each of the plurality of processors, corresponding data queues to be associated with the processor from the plurality of data queues, in a way that counts of the associated data queues among the plurality of processors are balanced, and the data queues of a same virtual network card are associated with different processors, respectively.

3. The load balancing method according to claim 1, wherein in response to determining that the load imbalance exists based on the load information of the plurality of processors, adjusting the data queues associated with the part of the plurality of processors comprises:
determining a first processor and a second processor in the plurality of processors according to the load information of the plurality of processors, wherein a load of the first processor meets a preset first requirement, and a load of the second processor meets a preset second requirement;
calculating a load difference between the first processor and the second processor;
in response to determining that the load difference is greater than a threshold value, adjusting data queues associated with the first processor and data queues associated with the second processor.

4. The load balancing method according to claim 3, wherein the first processor is associated with a plurality of data queues, and the second processor is associated with a plurality of data queues; and
adjusting the data queues associated with the first processor and the data queues associated with the second processor comprises:
obtaining a first load corresponding to each of the plurality of data queues associated with the first processor and a second load corresponding to each of the plurality of data queues associated with the second processor;
determining a queue adjustment scheme according to the first load corresponding to each of the plurality of data queues associated with the first processor, the second load corresponding to each of the plurality of data queues associated with the second processor, and the load difference;
adjusting the data queues associated with the first processor and the data queues associated with the second processor according to the queue adjustment scheme.

5. The load balancing method according to claim 4, wherein determining the queue adjustment scheme according to the first load corresponding to each of the plurality of data queues associated with the first processor, the second load corresponding to each of the plurality of data queues associated with the second processor, and the load difference comprises:
selecting one data queue from the plurality of data queues associated with the first processor as a first target queue based on the first load corresponding to each of the plurality of data queues associated with the first processor and the load difference;
based on the first load corresponding to each of the plurality of data queues associated with the first processor, the second load corresponding to each of the plurality of data queues associated with the second processor, and the load difference, selecting one data queue from the plurality of data queues associated with the first processor as a second target queue, and one data queue from the plurality of data queues associated with the second processor as a third target queue, respectively;
determining the queue adjustment scheme based on a load corresponding to the first target queue, a load corresponding to the second target queue, and a load corresponding to the third target queue.

6. The load balancing method according to claim 5, wherein selecting one data queue from the plurality of data queues associated with the first processor as the first target queue based on the first load corresponding to each of the plurality of data queues associated with the first processor and the load difference comprises:
calculating a first value of the first load corresponding to each of the plurality of data queues associated with the first processor relative to the load difference;
taking a data queue with a minimum first value among the plurality of data queues associated with the first processor as the first target queue.

7. The load balancing method according to claim 5, wherein based on the first load corresponding to each of the plurality of data queues associated with the first processor, the second load corresponding to each of the plurality of data queues associated with the second processor, and the load difference, selecting one data queue from the plurality of data queues associated with the first processor as a second target queue, and one data queue from the plurality of data queues associated with the second processor as a third target queue, respectively, comprises:
calculating an absolute difference of loads corresponding to two data queues in each of a plurality of queue groups according to the first load corresponding to each of the plurality of data queues associated with the first processor and the second load corresponding to each of the plurality of data queues associated with the second processor; wherein any one of the plurality of data queues associated with the first processor and any one of the plurality of data queues associated with the second processor constitute a queue group;
calculating a second value of an absolute difference corresponding to each of the plurality of queue groups relative to the load difference;
selecting a queue group with a minimum second value as a target group;
taking a data queue associated with the first processor in the target group as the second target queue, and taking a data queue associated with the second processor in the target group as the third target queue.

8. The load balancing method according to claim 5, wherein determining the queue adjustment scheme based on the load corresponding to the first target queue, the load corresponding to the second target queue, and the load corresponding to the third target queue comprises:
obtaining a first value of the load corresponding to the first target queue relative to the load difference;
obtaining a second value of an absolute difference between the load corresponding to the second target queue and the load corresponding to the third target queue relative to the load difference;
comparing the first value and the second value;
in response to determining that the first value is less than the second value, adopting a queue migration scheme to adjust the first target queue to be associated with the second processor;
in response to determining that the first value is not less than the second value, adopting a queue swap scheme to adjust the second target queue to be associated with the second processor and to adjust the third target queue to be associated with the first processor.

9. The load balancing method according to claim 2, wherein configuring, for each of the plurality of processors, corresponding data queues to be associated with the processor from the plurality of data queues comprises:
obtaining a network card count of the virtual network cards, a data queue count of the data queues corresponding to each virtual network card and a processor count of the plurality of processors;
determining a virtual network card number N, a data queue number M and a processor number X;
associating a data queue which is numbered M of a virtual network card which is numbered N, with a processor which is numbered X;
updating the number X based on the processor count;
incrementing the number M;
in response to determining that the incremented number M is greater than a queue count of the virtual network card numbered N, incrementing the number N; in response to determining the incremented number N is greater than the network card count, ending operations; and in response to determining the incremented number N is not greater than the network card count, updating the virtual network card number N to the incremented number N; and
in response to determining that the incremented number M is not greater than the queue count of the virtual network card numbered N, according to the incremented number M and the updated number X, triggering execution of a step of associating the data queue numbered M of the virtual network card numbered N with the processor numbered X.

10. The load balancing method according to claim 9, wherein updating the number X based on the processor count comprises:
incrementing the number X;
taking a remainder of the incremented number X divided by the processor count; and
updating the number X according to the obtained remainder.

11. A server, wherein the server comprises a plurality of processors, and a virtual switch and a plurality of virtual machines are run on the server;
the virtual switch is configured to forward data among the plurality of virtual machines and between the plurality of virtual machines and an external device connected with the server by using the plurality of processors, and is configured to determine one or more data queues associated with each of the plurality of processors; and each data queue is configured to store data to be forwarded, and each processor is configured to process data to be forwarded in the data queues associated with the processor; and the virtual switch is configured to monitor data to be forwarded in the data queues respectively to determine load information of each of the plurality of processors, and in response to determining that a load imbalance exists based on the load information of the plurality of processors, adjust data queues associated with a part of the plurality of processors.

12. A data center network system, wherein the system comprises a plurality of servers connected with a network,
each server comprises a plurality of processors, and a virtual switch and a plurality of virtual machines are run on the server;
the virtual switch is configured to forward data among the plurality of virtual machines and between the plurality of virtual machines and an external device connected with the server by using the plurality of processors, and is configured to determine one or more data queues associated with each of the plurality of processors; and each data queue is configured to store data to be forwarded, and each processor is configured to process data to be forwarded in the data queues associated with the processor; and the virtual switch is configured to monitor data to be forwarded in the data queues respectively to determine load information of each of the plurality of processors, and in response to determining that a load imbalance exists based on the load information of the plurality of processors, adjust data queues associated with a part of the plurality of processors.

13. An electronic device, comprising: a non-transitory storage and a plurality of processors, wherein
the non-transitory storage is configured to store one or more computer instructions;
the plurality of processors, respectively coupled to the non-transitory storage, are configured to call the one or more computer instructions to virtualize a virtual switch and a plurality of virtual machines in a server, wherein the virtual switch is configured to forward data among the plurality of virtual machines and between the plurality of virtual machines and an external device connected to the server by using the plurality of processors; and
the plurality of processors are further configured to balance loads of the plurality of processors through steps in the method according to claim 1.
